(19) United States
(12) Patent Application Publication
(10) Pub. No.: US 2026/0343497 A1
(43) Pub. Date: Oct. 29, 2026

(54) Communication Method, Communication Apparatus, and Communication System

(71) Applicant: HUAWEI TECHNOLOGIES CO., LTD., Shenzhen (CN)

(72) Inventors: Hejia Luo, Ottawa (CA); Chuili Kong, Hangzhou (CN); Xiaolu Wang, Hangzhou (CN); Jun Wang, Hangzhou (CN); Jianglei Ma, Ottawa (CA)

(73) Assignee: HUAWEI TECHNOLOGIES CO., LTD., Shenzhen (CN)

(21) Appl. No.: 19/706,472

(22) Filed: Jun. 12, 2026

Related U.S. Application Data
(63) Continuation of application No. PCT/CN2024/139151, filed on Dec. 13, 2024.

(30) Foreign Application Priority Data
Dec. 15, 2023 (CN) 202311734047.6

(51) Int. Cl. H04W 72/044; H04L 5/00

(52) U.S. Cl. CPC H04W 72/044; H04L 5/0005

(57) ABSTRACT

When a plurality of transmission nodes sequentially provides services for a terminal device based on a time sequence, a terminal device transmits information to each transmission node by using a same transmission resource in different time periods, and does not need to frequently switch an accessed transmission node. In addition, when data is transmitted with different transmission nodes, time-frequency configuration information of a corresponding transmission node is used to perform data transmission with the transmission node.

### CROSS-REFERENCE TO RELATED APPLICATIONS

This is a continuation of International Patent Application No. PCT/CN2024/139151 filed on Dec. 13, 2024, which claims priority to Chinese Patent Application No. 202311734047.6 filed on Dec. 15, 2023. The disclosures of the aforementioned applications are hereby incorporated by reference in their entireties.

### TECHNICAL FIELD

This disclosure relates to the field of wireless communication technologies, and in particular, to a communication method, a communication apparatus, and a communication system.

### BACKGROUND

Currently, 5th generation (5G) new radio (NR) has moved from the standardization stage to the commercial deployment stage. The NR standard is researched and designed based on characteristics of terrestrial communication, and features providing high-rate, high-reliability, and low-latency communication for users. Compared with the terrestrial communication, non-terrestrial network (NTN) communication has characteristics such as large coverage and flexible networking. Currently, research institutes, communication organizations, companies, and other entities participate in research on NTN communication technologies and standards, with the aim of building a unified communication network integrating space-air-ground communication.

The NTN communication includes networking by using devices such as an uncrewed aerial vehicle, a high-altitude platform station (HAPS), and a satellite, to provide services such as data transmission and voice communication for a terminal device.

Currently, communication of an NTN device has the following problems to be resolved.

First, high-speed movement of the NTN device causes a change in a relative position between the terminal device and the NTN device, resulting in frequent switching of an accessed NTN device by the terminal device. The terminal device may need to switch a transmission resource for communication, resulting in high signaling overheads.

Second, time-frequency locations at which beams of different NTN devices arrive at the terminal device differ greatly. After the terminal device switches to a new NTN device, the terminal device cannot correctly perform information transmission.

### SUMMARY

Embodiments of this disclosure provide a communication method, a communication apparatus, and a communication system, to reduce signaling overheads of a terminal device and implement correct information transmission.

According to a first aspect, an embodiment of this disclosure provides a communication method. The method may be performed by a terminal device or a module (for example, a chip) in a terminal device. The method includes: transmitting information on a first transmission resource in a first time period based on time-frequency configuration information of a first transmission node corresponding to the first transmission resource; and transmitting information on the first transmission resource in a second time period based on time-frequency configuration information of a second transmission node corresponding to the first transmission resource.

In the foregoing solution, when a plurality of transmission nodes sequentially provide services for a terminal device based on a time sequence, the terminal device transmits information to each transmission node by using a same transmission resource in different time periods, and does not need to frequently switch an accessed transmission node. Therefore, signaling overheads can be reduced. In addition, when data is transmitted with different transmission nodes, time-frequency configuration information of a corresponding transmission node is used to perform data transmission with the transmission node. Therefore, normal information transmission can be implemented, and correctness of information transmission can be improved.

In a possible implementation method, the first transmission resource includes one or more of the following resources: a synchronization signal/physical broadcast channel block (SSB) resource, an SSB resource set, an SSB resource set list, a reference signal resource, a reference signal resource set, a reference signal resource set list, a random access channel occasion (RO) resource, an RO resource set, or an RO resource set list.

In a possible implementation method, the time-frequency configuration information of the first transmission node includes one or more of the following information: ephemeris information of the first transmission node, downlink frequency pre-compensation information of the first transmission node, uplink frequency post-compensation information of the first transmission node, or timing compensation information of the first transmission node.

In a possible implementation method, the time-frequency configuration information of the second transmission node includes one or more of the following information: ephemeris information of the second transmission node, downlink frequency pre-compensation information of the second transmission node, uplink frequency post-compensation information of the second transmission node, or timing compensation information of the second transmission node.

In a possible implementation method, the method further includes: receiving configuration information from the first transmission node, where the configuration information includes the time-frequency configuration information of the second transmission node corresponding to the first transmission resource and effective time of the time-frequency configuration information of the second transmission node; and transmitting the information on the first transmission resource in the second time period based on the time-frequency configuration information of the second transmission node corresponding to the first transmission resource includes: after the effective time arrives, transmitting information on the first transmission resource in the second time period based on the time-frequency configuration information of the second transmission node.

In the foregoing solution, the to-be-used time-frequency configuration information is dynamically indicated, so that the time-frequency configuration information can be flexibly configured.

In a possible implementation method, the method further includes: receiving indication information from the first transmission node, where the indication information indicates the time-frequency configuration information of the second transmission node and effective time of the time-frequency configuration information of the second transmission node in a preconfigured time-frequency configuration set; and transmitting the information on the first transmission resource in the second time period based on the time-frequency configuration information of the second transmission node corresponding to the first transmission resource includes: after the effective time arrives, obtaining the time-frequency configuration information of the second transmission node from the time-frequency configuration set, and transmitting the information on the first transmission resource in the second time period based on the time-frequency configuration information of the second transmission node.

In the foregoing solution, the time-frequency configuration set is configured in advance, and then the to-be-used time-frequency configuration information of the transmission node in the time-frequency configuration set is dynamically indicated by using dynamic signaling. Therefore, the time-frequency configuration information can be flexibly configured, and signaling overheads in a dynamic configuration process can be reduced.

In a possible implementation method, transmitting the information on the first transmission resource in the second time period based on the time-frequency configuration information of the second transmission node corresponding to the first transmission resource includes: after preconfigured effective time of the time-frequency configuration information of the second transmission node arrives, obtaining the time-frequency configuration information of the second transmission node from a preconfigured time-frequency configuration set, and transmitting the information on the first transmission resource in the second time period based on the time-frequency configuration information of the second transmission node.

In the foregoing solution, the time-frequency configuration set and the effective time of the time-frequency configuration information of each transmission node in the time-frequency configuration set are configured in advance. Subsequently, after the effective time of the time-frequency configuration information of each transmission node arrives, the terminal device uses the time-frequency configuration information of the corresponding transmission node, so that the time-frequency configuration information can be flexibly configured, and signaling overheads are reduced. In addition, this solution can further enable configuration modification of the terminal device in a non-connected state.

In a possible implementation method, transmitting the information on the first transmission resource in the second time period based on the time-frequency configuration information of the second transmission node corresponding to the first transmission resource includes: when a reference signal received power (RSRP) of a reference signal associated with the time-frequency configuration information of the second transmission node is greater than a preset threshold, obtaining the time-frequency configuration information of the second transmission node from a preconfigured time-frequency configuration set, and transmitting the information on the first transmission resource in the second time period based on the time-frequency configuration information of the second transmission node.

In the foregoing solution, the time-frequency configuration set and an effective condition of the time-frequency configuration information of each transmission node in the time-frequency configuration set are configured in advance. Subsequently, after the effective condition of the time-frequency configuration information of each transmission node is met, the terminal device uses the time-frequency configuration information of the corresponding transmission node, so that the time-frequency configuration information can be flexibly configured, and signaling overheads are reduced. In addition, this solution can further enable configuration modification of the terminal device in a non-connected state.

According to a second aspect, an embodiment of this disclosure provides a communication method. The method may be performed by a first transmission node or a module (for example, a chip) in a first transmission node. The method includes: receiving time-frequency configuration information of a second transmission node and a service time period of the second transmission node from the second transmission node; and sending the time-frequency configuration information of the second transmission node and the service time period of the second transmission node to a terminal device served by the first transmission node.

In the foregoing solution, the time-frequency configuration information and the service time period of the transmission node that is to provide a service for the terminal device are configured for the terminal device in advance. In this way, the terminal device can perform information transmission by using the time-frequency configuration information of the corresponding transmission node after the service time period arrives, so that normal information transmission can be implemented and correctness of information transmission can be improved.

In a possible implementation method, the method further includes: sending information about a first transmission resource and information about a service location corresponding to the first transmission resource to the second transmission node, where the first transmission resource is a resource used by the first transmission node to provide a service.

In this solution, the first transmission node notifies the second transmission node of the information about the first transmission resource and the information about the service location corresponding to the first transmission resource in advance. Therefore, the second transmission node may subsequently communicate with the terminal device by using the first transmission resource. Accordingly, the terminal device uses the same transmission resource to transmit the information with each transmission node in different time periods, and does not need to frequently switch an accessed transmission node, thereby reducing signaling overheads.

In a possible implementation method, the method further includes: sending information about a first transmission resource and information about the terminal device to the second transmission node, where the first transmission resource is a resource used by the first transmission node to provide a service for the terminal device.

In this solution, the first transmission node notifies the second transmission node of the information about the first transmission resource and the information about the terminal device in advance. Therefore, the second transmission node may subsequently communicate with the terminal device by using the first transmission resource. Accordingly, the terminal device uses the same transmission resource to transmit the information with each transmission node in different time periods, and does not need to frequently switch an accessed transmission node, thereby reducing signaling overheads.

In a possible implementation method, the first transmission resource includes one or more of the following resources: an SSB resource, an SSB resource set, an SSB resource set list, a reference signal resource, a reference signal resource set, a reference signal resource set list, an RO resource, an RO resource set, or an RO resource set list.

In a possible implementation method, the method further includes: sending, to the second transmission node, time at which the first transmission node performs service handover with the second transmission node.

According to a third aspect, an embodiment of this disclosure provides a communication apparatus. The apparatus may be a terminal device or a module (for example, a chip) in a terminal device. The apparatus has a function of implementing any one of the implementation methods of the first aspect. The function may be implemented by hardware, or may be implemented by hardware executing corresponding software. The hardware or the software includes one or more modules corresponding to the function.

According to a fourth aspect, an embodiment of this disclosure provides a communication apparatus. The apparatus may be a first transmission node, or may be a module (for example, a chip) in a first transmission node. The apparatus has a function of implementing any one of the implementation methods of the second aspect. The function may be implemented by hardware, or may be implemented by hardware executing corresponding software. The hardware or the software includes one or more modules corresponding to the function.

According to a fifth aspect, an embodiment of this disclosure provides a communication apparatus, including a unit or means configured to perform steps of any one of the implementation methods according to the first aspect and the second aspect.

According to a sixth aspect, an embodiment of this disclosure provides a communication apparatus, including a processor and an interface circuit. The processor is configured to communicate with another apparatus through the interface circuit, and perform any one of the implementation methods according to the first aspect and the second aspect. There are one or more processors.

Optionally, the communication apparatus may further include a memory configured to store computer instructions. The memory is coupled to the processor, and the processor executes the computer instructions stored in the memory, to enable the apparatus to perform any one of the implementation methods of the first aspect and the second aspect.

According to a seventh aspect, an embodiment of this disclosure further provides a computer program product. The computer program product includes a computer program or instructions, and when the computer program or the instructions are run by a communication apparatus, any one of the implementation methods in the first aspect and the second aspect is enabled to be performed.

According to an eighth aspect, an embodiment of this disclosure further provides a computer-readable storage medium. The computer-readable storage medium stores instructions, and when the instructions are run on a communication apparatus, any one of the implementation methods in the first aspect is enabled to be performed.

According to a ninth aspect, an embodiment of this disclosure further provides a chip system, including a processor, configured to perform any one of the implementation methods in the first aspect and the second aspect.

According to a tenth aspect, an embodiment of this disclosure provides a communication system, including: a first transmission node, configured to receive time-frequency configuration information of a second transmission node and a service time period of the second transmission node from the second transmission node; and send the time-frequency configuration information of the second transmission node and the service time period of the second transmission node to a terminal device served by the first transmission node; and the second transmission node, configured to send the time-frequency configuration information of the second transmission node and the service time period of the second transmission node to the first transmission node.

In a possible implementation method, the first transmission node is further configured to send information about a first transmission resource and information about a service location corresponding to the first transmission resource to the second transmission node, where the first transmission resource is a resource used by the first transmission node to provide a service.

In a possible implementation method, the first transmission node is further configured to send the information about the first transmission resource and information about the terminal device to the second transmission node, where the first transmission resource is a resource used by the first transmission node to provide a service for the terminal device.

In a possible implementation method, the first transmission resource includes one or more of the following resources: an SSB resource, an SSB resource set, an SSB resource set list, a reference signal resource, a reference signal resource set, a reference signal resource set list, an RO resource, an RO resource set, or an RO resource set list.

In a possible implementation method, the first transmission node is further configured to send, to the second transmission node, time at which the first transmission node performs service handover with the second transmission node.

### BRIEF DESCRIPTION OF DRAWINGS

FIG. 1A is a diagram of a network architecture in a transparent mode in which an NTN is integrated with a terrestrial network;

FIG. 1B is a diagram of a network architecture in a regenerative mode in which an NTN is integrated with a terrestrial network;

FIG. 2 is a schematic flowchart of a communication method according to an embodiment of this disclosure;

FIG. 3 is a schematic flowchart of a communication method according to an embodiment of this disclosure;

FIG. 4 is a diagram of a structure of a communication apparatus according to an embodiment of this disclosure; and

FIG. 5 is a diagram of a structure of a communication apparatus according to an embodiment of this disclosure.

### DESCRIPTION OF EMBODIMENTS

Currently, 5G NR has moved from the standardization stage to the commercial deployment stage. An NR standard is researched and designed based on characteristics of terrestrial communication, and features providing high-rate, high-reliability, and low-latency communication for users. Compared with the terrestrial communication, NTN communication has characteristics such as large coverage and flexible networking. Currently, research institutes, communication organizations, companies, and other entities participate in research on NTN communication technologies and standards, with the aim of building a unified communication network integrating space-air-ground communication.

The NTN communication includes networking by using devices such as an uncrewed aerial vehicle, a HAPS, and a satellite, to provide services such as data transmission and voice communication for a terminal device. A high-altitude platform station is generally located at a height of 8 kilometers (km) to 50 km above the ground. According to the orbital altitude of a satellite, a satellite communication system can be classified into three types: a geostationary Earth orbit (GEO) satellite communication system (also referred to as a geosynchronous orbit satellite system), a medium Earth orbit (MEO) satellite communication system, and a low Earth orbit (LEO) satellite communication system. A GEO satellite has an orbital altitude of 35786 km. A main advantage is that the GEO satellite can remain stationary relative to the ground and provide a large coverage area. However, the GEO satellite has significant disadvantages: (1) An orbit of the GEO satellite is far away from the earth, and a free-space propagation loss is large. As a result, a communication link budget is tight. To increase a transmit/receive gain, the satellite may need to be equipped with a large-aperture antenna. (2) A communication transmission delay is high, and a round-trip delay may reach about 500 milliseconds (ms), which cannot meet a requirement of a real-time service. (3) GEO orbital resources are limited, launch costs are high, and coverage cannot be provided for polar areas of the earth. An orbital altitude of the MEO satellite ranges from 2000 km to 35786 km. An advantage is that global coverage can be implemented by using a smaller quantity of satellites. However, the MEO satellite has a higher orbital altitude than the LEO satellite, and a transmission delay is still longer than that of LEO satellite communication. Based on the advantage and the disadvantage of MEO satellite communication, the MEO satellite is mainly used for positioning and navigation. An LEO satellite orbits at an altitude of 300 km to 2000 km. The LEO satellite orbits at a lower altitude than the MEO and the GEO, and has advantages of a short data transmission delay, a small transmission loss, and relatively low launch costs. Therefore, the LEO satellite communication has also gained wide attention in recent years.

In the embodiments of this disclosure, the terminal device is a device having a wireless transceiver function, and may send a signal and/or receive a signal. The terminal device includes but is not limited to a terminal apparatus, a terminal, user equipment (UE), a mobile station, and a mobile terminal. The terminal device may be widely used in various scenarios, for example, device-to-device (D2D), vehicle-to-everything (V2X) communication, machine-type communication (MTC), an internet of things (IoT), virtual reality, augmented reality, industrial control, autonomous driving, remote medical, a smart grid, smart furniture, a smart office, a smart wearable, smart transportation, and a smart city. The terminal device may be a mobile phone, a tablet computer, a computer having a wireless transceiver function, a wearable device, a vehicle, an airplane, a ship, a robot, a robot arm, a smart home device, or the like. A specific technology and a specific device form that are used for the terminal device are not limited in embodiments of this disclosure.

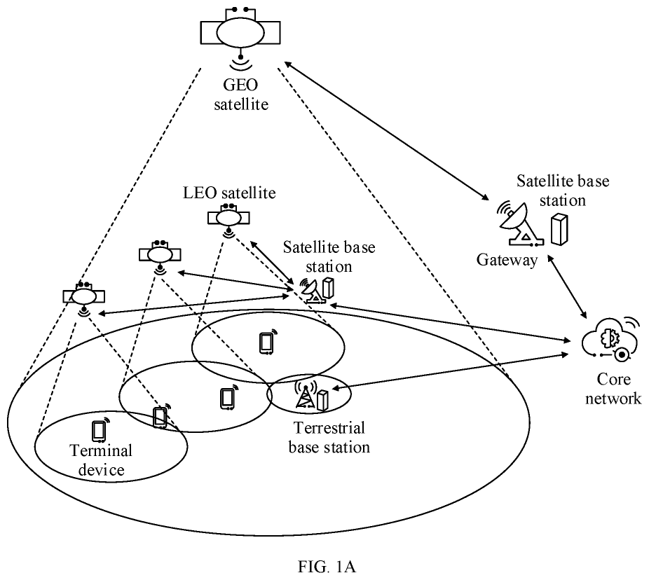

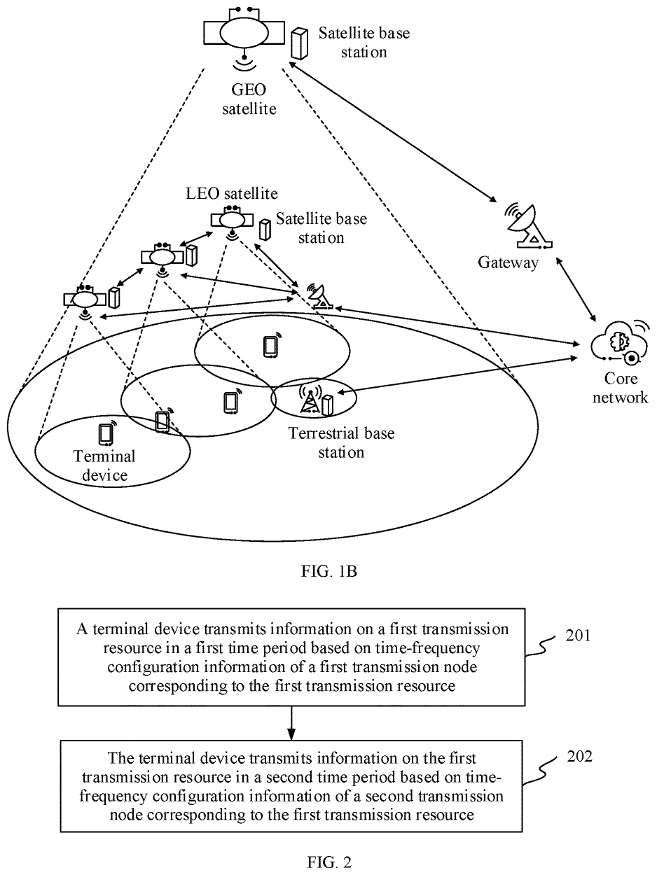

A working mode of the NTN device includes a transparent mode and a regenerative mode. FIG. 1A is a diagram of a network architecture in a transparent mode in which an NTN is integrated with a terrestrial network. In the diagram, an example in which the NTN device is a satellite is used. In actual application, the NTN device may alternatively be a high-altitude platform station, an uncrewed aerial vehicle, or the like. When the satellite operates in the transparent mode, the satellite has a relay and forwarding function. A gateway (also referred to as a gateway station, a ground station, a teleport, or the like) has functions of a network device (for example, a base station) or some functions of a network device. In this case, the gateway may be considered as the network device. Alternatively, the network device and the gateway may be deployed separately. In this case, a delay of a feeder link includes a delay from the satellite to the gateway and a delay from the gateway to the network device. FIG. 1B is a diagram of a network architecture in a regenerative mode in which an NTN is integrated with a terrestrial network. In the diagram, an example in which the NTN device is a satellite is used. In actual application, the NTN device may alternatively be a high-altitude platform station, an uncrewed aerial vehicle, or the like. When the satellite operates in the regenerative mode, the satellite has a data processing capability, that is, has functions of the network device (for example, a base station) or some functions of the network device. In this case, the satellite may be considered as the network device.

Currently, the communication of an NTN device has the following problems to be resolved.

First, high-speed movement of the NTN device causes a change in a relative position between the terminal device and the NTN device, resulting in frequent switching of an accessed NTN device by the terminal device. The terminal device may need to switch a transmission resource for communication, resulting in high signaling overheads.

Second, time-frequency locations at which beams of different NTN devices arrive at the terminal device differ greatly. After the terminal device switches to a new NTN device, the terminal device cannot correctly perform information transmission.

To resolve the foregoing problems, this disclosure provides corresponding embodiments. The following provides detailed descriptions.

FIG. 2 is a schematic flowchart of a communication method according to an embodiment of this disclosure. The method is performed by a terminal device or a module (for example, a chip) of a terminal device. The following uses an example in which the terminal device performs the method for description. The first transmission node described below may be an NTN device, or may be a function module in an NTN device, for example, a base station module or a communication module. The second transmission node described below may be an NTN device, or may be a function module in an NTN device, for example, a base station module or a communication module.

The method includes the following steps.
Step 201: A terminal device transmits information on a first transmission resource in a first time period based on time-frequency configuration information of a first transmission node corresponding to the first transmission resource.

The first transmission resource is also referred to as a beam resource. The first transmission resource includes one or more of the following resources: an SSB resource, an SSB resource set, an SSB resource set list, a reference signal resource, a reference signal resource set, a reference signal resource set list, an RO resource, an RO resource set, or an RO resource set list. One resource set list includes a plurality of resource sets, and one resource set includes a plurality of resources. The reference signal herein may be a channel state information-reference signal (CSI-RS), a demodulation reference signal (DMRS), a sounding reference signal (SRS), or the like.

The time-frequency configuration information of the first transmission node includes one or more of the following information (1) to (4):
(1) Ephemeris information of the first transmission node.

The ephemeris information includes, for example, at least one of a running speed or location information of the NTN device.
(2) Downlink frequency pre-compensation information of the first transmission node.

The downlink frequency pre-compensation information indicates a frequency offset value compensated by the satellite when the satellite sends a signal.
(3) Uplink frequency post-compensation information of the first transmission node.

The uplink frequency post-compensation information indicates a frequency offset value compensated by the satellite when the satellite receives a signal.
(4) Timing compensation information of the first transmission node.

For example, the timing compensation information includes at least one of commonTA, TA rate, Kmac, and Koffset. commonTA is used to determine a timing advance (TA) compensation amount used when the terminal device accesses the first transmission node. TA rate indicates a TA change rate. Kmac indicates an additional time offset for downlink media access control (MAC) signaling to take effect. Koffset indicates an additional time offset for uplink scheduling.

For example, a potential protocol representation form of the time-frequency configuration information of the first transmission node (for example, the satellite) is as follows:

| | |
|---|---|
| SAT-Config ::= | SEQUENCE { |
| sat-ConfigID | Sat-ConfigID, |
| ephemeris | Ephemeris, // sat location, speed |
| commonTA | INTEGER (0..N), // for TA compensation at UE |
| TARate | INTEGER (0..N), // for autonomous TA adjustment at UE |
| DLfreqPrecom | INTEGER (0..N), // for SAT Doppler pre-compensation |
| ULfreqPoscom | INTEGER (0..N), // for SAT Doppler post-compensation |

...
}

Herein, sat-ConfigID is a name of the configuration, and is used to index the time-frequency configuration information of the first transmission node. ephemeris is ephemeris information, commonTA is used to determine a TA compensation amount used when the terminal device accesses the first transmission node, DLfreqPrecom represents downlink frequency pre-compensation information, and ULfreqPoscom represents uplink frequency post-compensation information.

For example, when the first transmission resource includes a CSI-RS resource set list, a potential protocol expression form after the CSI-RS resource set list is associated with the time-frequency configuration information of the first transmission node (for example, the satellite) is as follows:

| | |
|---|---|
| CSI-ResourceConfig ::= | SEQUENCE { |
| csi-ResourceConfigId | CSI-ResourceConfigId, |
| csi-RS-ResourceSetList | CHOICE { |

```
  nzp-CSI-RS-ResouceSetListSEQUENCE (...)
  ...
}
...
```

| | |
|---|---|
| sat-ConfigID | Sat-ConfigID // time-frequency |

configuration information of the associated satellite
}

For example, when the first transmission resource includes a CSI-RS resource, a potential protocol expression form after the CSI-RS resource is associated with the time-frequency configuration information of the first transmission node (for example, the satellite) is as follows:

| | |
|---|---|
| NZP-CSI-RS-Resouce ::= | SEQUENCE { |
| nzp-CSI-RS-ResouceID | NZP-CSI-RS-ResoucneID, |
| resrouceMapping | CSI-RS-ResouceMapping |

...

| | |
|---|---|
| sat-ConfigID | Sat-ConfigID // time-frequency configuration information |

of the associated satellite
}

Step 202: The terminal device transmits information on the first transmission resource in a second time period based on time-frequency configuration information of a second transmission node corresponding to the first transmission resource.

The second time period is located after the first time period in a time sequence, that is, the second time period is a time period after the first time period. It should be noted that the second time period may be non-overlapping with the first time period, or may partially overlap with the first time period. This is not limited in this disclosure.

The time-frequency configuration information of the second transmission node includes one or more of the following information: ephemeris information of the second transmission node, downlink frequency pre-compensation information of the second transmission node, uplink frequency post-compensation information of the second transmission node, or timing compensation information of the second transmission node. For explanations of meanings and functions of the information, refer to the foregoing related explanations of the time-frequency configuration information of the first transmission node. Details are not described herein again.

In the foregoing solution, when a plurality of transmission nodes sequentially provide services for a terminal device based on a time sequence, the terminal device transmits information to each transmission node by using a same transmission resource in different time periods, and does not need to frequently switch an accessed transmission node. Therefore, signaling overheads can be reduced. In addition, when data is transmitted with different transmission nodes, time-frequency configuration information of a corresponding transmission node is used to perform data transmission with the transmission node. Therefore, normal information transmission can be implemented, and correctness of information transmission can be improved.

The following describes different implementation methods of time-frequency configuration information used by the terminal device for switching.
Implementation method 1: The first transmission node dynamically notifies the terminal device of to-be-used time-frequency configuration information and effective time.

For example, the first transmission node sends configuration information to the terminal device, where the configuration information includes the time-frequency configuration information of the second transmission node corresponding to the first transmission resource and the effective time of the time-frequency configuration information of the second transmission node. In this case, step 202 may be: After the effective time arrives, the terminal device transmits the information on the first transmission resource in the second time period based on the time-frequency configuration information of the second transmission node.

For example, the configuration information may be downlink control information (DCI), radio resource control (RRC) signaling, a media access control control element (MAC CE), or the like. The implementation mode of the configuration information is also applicable to the following implementation method 2 to implementation method 4. A unified description is provided herein, and details are not described below.

In an implementation method, the effective time may be a time point, indicating that after the time point arrives, the terminal device may perform data transmission on the first transmission resource by using the time-frequency configuration information of the corresponding transmission node. Taking the second transmission node as an example, if the effective time corresponding to the second transmission node is a time point before the second time period or start time of the second time period, indicating that after the effective time arrives, the terminal device may perform data transmission on the first transmission resource by using the time-frequency configuration information of the second transmission node.

In another implementation method, the effective time may also be a time period, indicating an effective time range of the corresponding time-frequency configuration information. In this case, the effective time is also referred to as a service time period of the transmission node. Taking the second transmission node as an example, if the service time period of the second transmission node is the second time period, the effective time of the time-frequency configuration information of the second transmission node is the second time period.

The implementation mode of the effective time is also applicable to the following implementation method 2 to implementation method 4. A unified description is provided herein, and details are not described below.

In the foregoing implementation method 1, the to-be-used time-frequency configuration information is dynamically indicated, so that the time-frequency configuration information can be flexibly configured.

In the implementation method 2, the first transmission node configures the time-frequency configuration set for the terminal device in advance, and subsequently indicates, via indication information, to-be-used time-frequency configuration information and effective time of a transmission node subsequently. The time-frequency configuration information includes time-frequency configuration information of one or more transmission nodes that can be used by the terminal device.

For example, before step 201, the first transmission node or another transmission node sends configuration information to the terminal device, where the configuration information includes a time-frequency configuration set. For example, the time-frequency configuration set includes the time-frequency configuration information of the first transmission node, the time-frequency configuration information of the second transmission node, and the like. After step 201 and before step 202, the first transmission node sends indication information to the terminal device, where the indication information indicates the time-frequency configuration information of the second transmission node and the effective time of the time-frequency configuration information of the second transmission node in the time-frequency configuration set. Step 202 may be: After the effective time arrives, the terminal device obtains the time-frequency configuration information of the second transmission node from the time-frequency configuration set, and transmits information on the first transmission resource in the second time period based on the time-frequency configuration information of the second transmission node.

In the foregoing implementation method 2, the time-frequency configuration set is configured in advance, and then the to-be-used time-frequency configuration information of the transmission node in the time-frequency configuration set is dynamically indicated by using dynamic signaling. Therefore, the time-frequency configuration information can be flexibly configured, and signaling overheads in a dynamic configuration process can be reduced.

In the implementation method 3, the first transmission node configures, in advance for the terminal device, the time-frequency configuration set and the effective time of the time-frequency configuration information of each transmission node in the time-frequency configuration set. Subsequently, after the effective time of the time-frequency configuration information of each transmission node arrives, the terminal device uses the time-frequency configuration information of the corresponding transmission node. The time-frequency configuration information includes time-frequency configuration information of one or more transmission nodes that can be used by the terminal device.

For example, before step 201, the first transmission node or another transmission node sends configuration information to the terminal device, where the configuration information includes the time-frequency configuration set and the effective time of the time-frequency configuration information of each transmission node in the time-frequency configuration set. For example, the time-frequency configuration set includes the time-frequency configuration information of the first transmission node, the time-frequency configuration information of the second transmission node, and the like. Step 202 may be: After the effective time of the time-frequency configuration information of the second transmission node arrives, the terminal device obtains the time-frequency configuration information of the second transmission node from the time-frequency configuration set, and transmits information on the first transmission resource in the second time period based on the time-frequency configuration information of the second transmission node.

In the foregoing implementation method 3, the time-frequency configuration set and the effective time of the time-frequency configuration information of each transmission node in the time-frequency configuration set are configured in advance. Subsequently, after the effective time of the time-frequency configuration information of each transmission node arrives, the terminal device uses the time-frequency configuration information of the corresponding transmission node, so that the time-frequency configuration information can be flexibly configured, and signaling overheads are reduced. In addition, the implementation method 3 can further enable configuration modification of the terminal device in a non-connected state.

In the implementation method 4, the first transmission node configures, in advance for the terminal device, the time-frequency configuration set and the effective condition of the time-frequency configuration information of each transmission node in the time-frequency configuration set. Subsequently, after an effective condition of the time-frequency configuration information of each transmission node is met, the terminal device uses the time-frequency configuration information of the corresponding transmission node. The time-frequency configuration information includes time-frequency configuration information of one or more transmission nodes that can be used by the terminal device.

For example, before step 201, the first transmission node or another transmission node sends configuration information to the terminal device, where the configuration information includes the time-frequency configuration set and the effective condition of the time-frequency configuration information of each transmission node in the time-frequency configuration set. For example, the time-frequency configuration set includes the time-frequency configuration information of the first transmission node, the time-frequency configuration information of the second transmission node, and the like. Step 202 may be: After the effective condition of the time-frequency configuration information of the second transmission node is met, the terminal device obtains the time-frequency configuration information of the second transmission node from the time-frequency configuration set, and transmits information on the first transmission resource in the second time period based on the time-frequency configuration information of the second transmission node.

For example, the effective condition may be that an RSRP of a reference signal (for example, an SSB, a CSI-RS, or an SRS) associated with the time-frequency configuration information of the transmission node is greater than a preset threshold. In this case, step 202 may be: When the RSRP of the reference signal associated with the time-frequency configuration information of the second transmission node is greater than the preset threshold, the terminal device obtains the time-frequency configuration information of the second transmission node from the time-frequency configuration set, and transmits the information on the first transmission resource in the second time period based on the time-frequency configuration information of the second transmission node.

In the foregoing implementation method 4, the time-frequency configuration set and an effective condition of the time-frequency configuration information of each transmission node in the time-frequency configuration set are configured in advance. Subsequently, after the effective condition of the time-frequency configuration information of each transmission node is met, the terminal device uses the time-frequency configuration information of the corresponding transmission node, so that the time-frequency configuration information can be flexibly configured, and signaling overheads are reduced. In addition, the implementation method 4 can further enable configuration modification of the terminal device in a non-connected state.

For the foregoing implementation method 1 to the implementation method 3, the following provides a specific example by using an example in which the transmission resource is an SSB resource and the transmission node is a satellite, as shown in Table 1.

TABLE 1

| | Time-frequency | |
|---|---|---|
| | configuration | |
| | information of the | |
| | associated satellite | Effective time |
| SSB resource #1 | Sat-ConfigID #1 | t0 to t1 |
| | Sat-ConfigID #2 | t1 to t2 |
| | Sat-ConfigID #3 | t2 to t3 |

Sat-ConfigID #1, Sat-ConfigID #2, and Sat-ConfigID #3 respectively represent time-frequency configuration information of the first satellite, time-frequency configuration information of the second satellite, and time-frequency configuration information of the third satellite, and corresponding effective time is a time period, which is respectively t0 to t1, t1 to t2, and t2 to t3.

For the foregoing implementation method 4, the following provides a specific example by using an example in which the transmission resource is a CSI-RS resource and the transmission node is a satellite, as shown in Table 2.

TABLE 2

| | Time-frequency | |
|---|---|---|
| | configuration | |
| | information of the | |
| | associated satellite | Effective condition |
| CRS-RS resource #1 | Sat-ConfigID #1 | An RSRP of an SSB 0 is |
| | | greater than a threshold 1 |
| | Sat-ConfigID #2 | An RSRP of an SSB 1 is |
| | | greater than a threshold 2 |
| | Sat-ConfigID #3 | An RSRP of an SSB 2 is |
| | | greater than a threshold 3 |

Sat-ConfigID #1, Sat-ConfigID #2, and Sat-ConfigID #3 respectively represent time-frequency configuration information of a first satellite, time-frequency configuration information of a second satellite, and time-frequency configuration information of a third satellite, and corresponding effective conditions are respectively: The RSRP of the SSB 0 is greater than the threshold 1, the RSRP of the SSB 1 is greater than the threshold 2, and the RSRP of the SSB 2 is greater than the threshold 3. A value relationship between the threshold 1, the threshold 2, and the threshold 3 is not limited. The thresholds may be all the same, or any two of the thresholds are the same, or the thresholds may be all different.

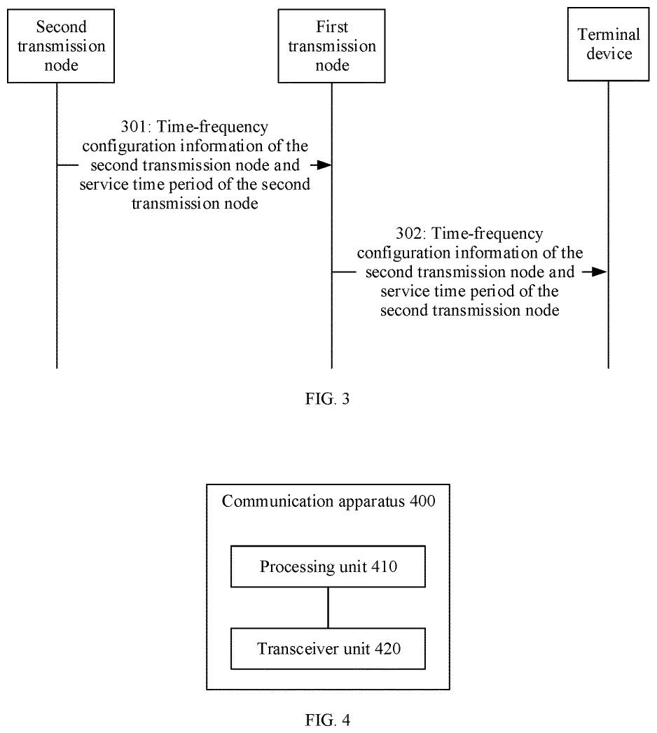

FIG. 3 is a schematic flowchart of a communication method according to an embodiment of this disclosure. The method is performed by a first transmission node or a module (for example, a chip) of a first transmission node, and a second transmission node or a module (for example, a chip) of a second transmission node. The following uses an example in which the first transmission node and the second transmission node perform the method for description. The first transmission node may be an NTN device, or may be a function module in an NTN device, for example, a base station module or a communication module. The second transmission node may be an NTN device, or may be a function module in an NTN device, for example, a base station module or a communication module.

The method includes the following steps.
Step 301: The second transmission node sends time-frequency configuration information of the second transmission node and a service time period of the second transmission node to the first transmission node.

For specific content and meanings included in the time-frequency configuration information of the second transmission node, refer to related descriptions in the embodiment in FIG. 2. Details are not described herein again.

The service time period of the second transmission node is a time range in which the second transmission node can provide a service for a terminal device currently served by the first transmission node or a current service area of the first transmission node.

The first transmission node may be a transmission node that currently provides a service for the terminal device, and therefore may be referred to as a serving transmission node. The second transmission node is a transmission node that subsequently provides a service for the terminal device, and therefore may be referred to as a relay transmission node.
Step 302: The first transmission node sends the time-frequency configuration information of the second transmission node and the service time period of the second transmission node to the terminal device served by the first transmission node.

In the foregoing solution, the time-frequency configuration information and the service time period of the transmission node that is to provide a service for the terminal device are configured for the terminal device in advance. In this way, the terminal device can perform information transmission by using the time-frequency configuration information of the corresponding transmission node after the service time period arrives, so that normal information transmission can be implemented and correctness of information transmission can be improved.

In an implementation method, the first transmission node may further send information about the first transmission resource and information about a service location corresponding to the first transmission resource to the second transmission node, where the first transmission resource is a resource used by the first transmission node to provide a service. Optionally, the first transmission node further sends, to the second transmission node, time at which the first transmission node performs service handover with the second transmission node. In this solution, the first transmission node notifies the second transmission node of the information about the first transmission resource and the information about the service location corresponding to the first transmission resource in advance. Therefore, the second transmission node may subsequently communicate with the terminal device by using the first transmission resource. Accordingly, the terminal device uses the same transmission resource to transmit the information with each transmission node in different time periods, and does not need to frequently switch an accessed transmission node, thereby reducing signaling overheads. For example, the following Table 3 provides an example of the information about the first transmission resource and the information about the service location corresponding to the first transmission resource. In this example, the first transmission resource is an SSB resource.

TABLE 3

| First | Service | Service handover |
|---|---|---|
| transmission resource | location | time (optional) |
| SSB resource #0 | Location #1 | t0 |
| SSB resource #1 | Location #2 | t1 |
| . . . | . . . | . . . |

In another implementation method, the first transmission node may further send information about the first transmission resource and information about the terminal device to the second transmission node, where the first transmission resource is a resource used by the first transmission node to provide a service for the terminal device. Optionally, the first transmission node further sends, to the second transmission node, time at which the first transmission node performs service handover with the second transmission node. In this solution, the first transmission node notifies the second transmission node of the information about the first transmission resource and the information about the terminal device in advance. Therefore, the second transmission node may subsequently communicate with the terminal device by using the first transmission resource. Accordingly, the terminal device uses the same transmission resource to transmit the information with each transmission node in different time periods, and does not need to frequently switch an accessed transmission node, thereby reducing signaling overheads. For example, the following Table 4 provides an example of the information about the first transmission resource and the information about the terminal device. In this example, the first transmission resource is a CRI-RS resource.

TABLE 4

| First | | Service handover |
|---|---|---|
| transmission resource | Identifier of a terminal device | time (optional) |
| CRI-RS resource #0 | Terminal devices #1 to #10 | t0 |
| CRI-RS resource #1 | Terminal devices #2 to #20 | t1 |
| . . . | . . . | . . . |

It may be understood that, to implement the functions in the foregoing embodiments, the terminal device, the first transmission node, or the second transmission node includes a corresponding hardware structure and/or software module for performing each function. A person skilled in the art should be easily aware that, in this disclosure, the units and method steps in the examples described with reference to embodiments disclosed in this disclosure can be implemented in a form of hardware or a combination of hardware and computer software. Whether a function is performed by hardware or hardware driven by computer software depends on particular application scenarios and design constraints of the technical solutions.

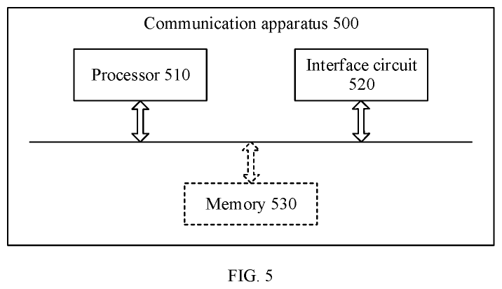

FIG. 4 and FIG. 5 are diagrams of structures of possible communication apparatuses according to embodiments of this disclosure. These communication apparatuses may be configured to implement functions of the terminal device or the first transmission node in the foregoing method embodiments, and therefore can also achieve beneficial effects of the foregoing method embodiments. In embodiments of this disclosure, the communication apparatus may be a terminal device or a first transmission node, or may be a module (for example, a chip) applied to the terminal device or the first transmission node.

A communication apparatus 400 shown in FIG. 4 includes a processing unit 410 and a transceiver unit 420. The communication apparatus 400 is configured to implement functions of the terminal device or the first transmission node in the foregoing method embodiments.

When the communication apparatus 400 is configured to implement the functions of the terminal device in the foregoing method embodiments, the processing unit 410 is configured to: control the transceiver unit 420 to transmit information on a first transmission resource in a first time period based on time-frequency configuration information of the first transmission node corresponding to the first transmission resource; and transmit information on the first transmission resource in a second time period based on time-frequency configuration information of a second transmission node corresponding to the first transmission resource.

In a possible implementation method, the first transmission resource includes one or more of the following resources: an SSB resource, an SSB resource set, an SSB resource set list, a reference signal resource, a reference signal resource set, a reference signal resource set list, an RO resource, an RO resource set, or an RO resource set list.

In a possible implementation method, the time-frequency configuration information of the first transmission node includes one or more of the following information: ephemeris information of the first transmission node, downlink frequency pre-compensation information of the first transmission node, uplink frequency post-compensation information of the first transmission node, or timing compensation information of the first transmission node.

In a possible implementation method, the time-frequency configuration information of the second transmission node includes one or more of the following information: ephemeris information of the second transmission node, downlink frequency pre-compensation information of the second transmission node, uplink frequency post-compensation information of the second transmission node, or timing compensation information of the second transmission node.

In a possible implementation method, the processing unit 410 is further configured to control the transceiver unit 420 to receive configuration information from the first transmission node, where the configuration information includes time-frequency configuration information of the second transmission node corresponding to the first transmission resource and effective time of the time-frequency configuration information of the second transmission node; and that the processing unit 410 is configured to control the transceiver unit 420 to transmit the information on the first transmission resource in the second time period based on the time-frequency configuration information of the second transmission node corresponding to the first transmission resource includes: After the effective time arrives, the processing unit 410 is configured to transmit the information on the first transmission resource in the second time period based on the time-frequency configuration information of the second transmission node.

In a possible implementation method, the processing unit 410 is further configured to control the transceiver unit 420 to receive indication information from the first transmission node, where the indication information indicates the time-frequency configuration information of the second transmission node and effective time of the time-frequency configuration information of the second transmission node in a preconfigured time-frequency configuration set; and that the processing unit 410 is configured to control the transceiver unit 420 to transmit the information on the first transmission resource in the second time period based on the time-frequency configuration information of the second transmission node corresponding to the first transmission resource includes: After the effective time arrives, the processing unit 410 is configured to obtain the time-frequency configuration information of the second transmission node from the time-frequency configuration set, and transmit information on the first transmission resource in the second time period based on the time-frequency configuration information of the second transmission node.

In a possible implementation method, that the processing unit 410 is configured to control the transceiver unit 420 to transmit the information on the first transmission resource in the second time period based on the time-frequency configuration information of the second transmission node corresponding to the first transmission resource includes: After preconfigured effective time of the time-frequency configuration information of the second transmission node arrives, the processing unit 410 is configured to obtain the time-frequency configuration information of the second transmission node from a preconfigured time-frequency configuration set, and transmit the information on the first transmission resource in the second time period based on the time-frequency configuration information of the second transmission node.

In a possible implementation method, that the processing unit 410 is configured to control the transceiver unit 420 to transmit the information on the first transmission resource in the second time period based on the time-frequency configuration information of the second transmission node corresponding to the first transmission resource includes: When the RSRP of the reference signal associated with the time-frequency configuration information of the second transmission node is greater than a preset threshold, the processing unit 410 is configured to obtain the time-frequency configuration information of the second transmission node from a preconfigured time-frequency configuration set, and transmit the information on the first transmission resource in the second time period based on the time-frequency configuration information of the second transmission node.

When the communication apparatus 400 is configured to implement the functions of the first transmission node in the foregoing method embodiments, the processing unit 410 is configured to control the transceiver unit 420 to receive time-frequency configuration information of the second transmission node and a service time period of the second transmission node from the second transmission node; and send the time-frequency configuration information of the second transmission node and the service time period of the second transmission node to a terminal device served by the first transmission node.

In a possible implementation method, the processing unit 410 is further configured to control the transceiver unit 420 to send information about a first transmission resource and information about a service location corresponding to the first transmission resource to the second transmission node, where the first transmission resource is a resource used by the first transmission node to provide a service.

In a possible implementation method, the processing unit 410 is further configured to control the transceiver unit 420 to send information about a first transmission resource and information about the terminal device to the second transmission node, where the first transmission resource is a resource used by the first transmission node to provide a service for the terminal device.

In a possible implementation method, the first transmission resource includes one or more of the following resources: an SSB resource, an SSB resource set, an SSB resource set list, a reference signal resource, a reference signal resource set, a reference signal resource set list, an RO resource, an RO resource set, or an RO resource set list.

In a possible implementation method, the processing unit 410 is further configured to control the transceiver unit 420 to send, to the second transmission node, time at which the first transmission node performs service handover with the second transmission node.

For more detailed descriptions about the processing unit 410 and the transceiver unit 420, directly refer to related descriptions in the foregoing method embodiments. Details are not described herein again.

A communication apparatus 500 shown in FIG. 5 includes a processor 510 and an interface circuit 520. The processor 510 and the interface circuit 520 are coupled to each other. It may be understood that the interface circuit 520 may be a transceiver or an input/output interface. Optionally, the communication apparatus 500 may further include a memory 530 configured to store instructions to be executed by the processor 510, store input data for the processor 510 to run the instructions, or store data generated after the processor 510 runs the instructions.

When the communication apparatus 500 is configured to implement the foregoing method embodiments, the processor 510 is configured to implement a function of the processing unit 410, and the interface circuit 520 is configured to implement a function of the transceiver unit 420.

It may be understood that, the processor in embodiments of this disclosure may be a central processing unit (CPU), or may be another general-purpose processor, a digital signal processor (DSP), an application-specific integrated circuit (ASIC), a field-programmable gate array (FPGA) or another programmable logic device, a transistor logic device, a hardware component, or any combination thereof. The general purpose processor may be a microprocessor or any regular processor or the like.

The method steps in embodiments of this disclosure may be implemented in a hardware manner, or may be implemented in a manner of executing software instructions by the processor. The software instruction may be composed of corresponding software modules. The software modules may be stored in a random access memory, a flash memory, a read-only memory, a programmable read-only memory, an erasable programmable read-only memory, an electrically erasable programmable read-only memory, a register, a hard disk, a removable hard disk, and a compact optical disk read-only memory (CD-ROM) or any other form of storage medium well known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in the terminal device or the first transmission node. It is clear that the processor and the storage medium may also exist in an access network device or a terminal as discrete components.

All or some of the foregoing embodiments may be implemented by using software, hardware, firmware, or any combination thereof. When the software is used for implementation, some or all of the foregoing embodiments may be implemented in a form of a computer program product. The computer program product includes one or more computer programs or instructions. The computer program is a set of instructions that indicate each step of an action of an electronic computer or another device having a message processing capability, and is usually written in a program design language and run on a target architecture. When the computer programs or instructions are loaded and executed on a computer, procedures or functions in embodiments of this disclosure are all or partially executed. The computer may be a general-purpose computer, a dedicated computer, a computer network, or another programmable apparatus. The computer program or instructions may be stored in a computer-readable storage medium, or may be transmitted from a computer-readable storage medium to another computer-readable storage medium. For example, the computer program or instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In various embodiments of this disclosure, unless otherwise stated or if there is a logic conflict, terms and/or descriptions in different embodiments are consistent and may be mutually referenced, and technical features in different embodiments may be combined into a new embodiment based on an internal logical relationship thereof.

In this disclosure, at least one means one or more, and a plurality of means two or more. The term “and/or” describes an association relationship between associated objects, and represents that three relationships may exist. For example, A and/or B may represent the following cases: Only A exists, both A and B exist, and only B exists, where A and B may be singular or plural. In the text descriptions of this disclosure, the character “/” indicates an “or” relationship between the associated objects. In a formula in this disclosure, the character “/” indicates a “division” relationship between the associated objects.

It may be understood that various numbers in embodiments of this disclosure are merely used for differentiation for ease of description, and are not used to limit the scope of embodiments of this disclosure. Sequence numbers of the foregoing processes do not mean an execution sequence, and the execution sequence of the processes should be determined based on functions and internal logic of the processes.

1. A method, applied to a terminal device or a module in the terminal device, wherein the method comprises:
transmitting, based on first time-frequency configuration information of a first transmission node, first information on a first transmission resource in a first time period, wherein the first transmission node corresponds to the first transmission resource; and
transmitting, based on second time-frequency configuration information of a second transmission node, second information on the first transmission resource in a second time period wherein the second transmission node corresponds to the first transmission resource.

2. The method of claim 1, wherein the first transmission resource comprises one or more of a synchronization signal/physical broadcast channel block (SSB) resource, an SSB resource set, an SSB resource set list, a reference signal resource, a reference signal resource set, a reference signal resource set list, a random access channel occasion (RO) resource, an RO resource set, or an RO resource set list.

3. The method of claim 1, wherein the first time-frequency configuration information comprises one or more of ephemeris information of the first transmission node, downlink frequency pre-compensation information of the first transmission node, uplink frequency post-compensation information of the first transmission node, or timing compensation information of the first transmission node.

4. The method of claim 1, wherein the second time-frequency configuration information comprises one or more of ephemeris information of the second transmission node, downlink frequency pre-compensation information of the second transmission node, uplink frequency post-compensation information of the second transmission node, or timing compensation information of the second transmission node.

5. The method of claim 1, further comprising receiving configuration information from the first transmission node, wherein the configuration information comprises the second time-frequency configuration information and an effective time of the second time-frequency configuration information and wherein transmitting the second information on the first transmission resource in the second time period comprises transmitting, based on the second time-frequency configuration information and after the effective time arrives, the second information.

6. The method of claim 1, further comprising:
receiving indication information from the first transmission node, wherein the indication information indicates the second time-frequency configuration information and an effective time of the second time-frequency configuration information in a preconfigured time-frequency configuration set; and
obtaining, after the effective time arrives and before transmitting the second information, the second time-frequency configuration information from the preconfigured time-frequency configuration set.

7. The method of claim 1, wherein transmitting the second information on the first transmission resource in the second time period comprises:
obtaining, after preconfigured effective time of the second time-frequency configuration information arrives, the second time-frequency configuration information from a preconfigured time-frequency configuration set; and
transmitting, based on the second time-frequency configuration information, the first information on the first transmission resource in the second time period.

8. A terminal device or a module in the terminal device, the terminal device or the module comprising:
a memory configured to store programming instructions, and
at least one processor coupled to the memory and configured to execute the programming instructions to cause the terminal device to:
transmit, based on first time-frequency configuration information of a first transmission node, first information on a first transmission resource in a first time period, wherein the first transmission node corresponds to the first transmission resource; and
transmit, based on second time-frequency configuration information of a second transmission node, second information on the first transmission resource in a second time period, wherein the second transmission node corresponds to the first transmission resource.

9. The terminal device of claim 8, wherein the first transmission resource comprises one or more of: a synchronization signal/physical broadcast channel block (SSB) resource, an SSB resource set, an SSB resource set list, a reference signal resource, a reference signal resource set, a reference signal resource set list, a random access channel occasion (RO) resource, an RO resource set, or an RO resource set list.

10. The terminal device of claim 8, wherein the first time-frequency configuration information comprises one or more of: ephemeris information of the first transmission node, downlink frequency pre-compensation information of the first transmission node, uplink frequency post-compensation information of the first transmission node, or timing compensation information of the first transmission node.

11. The terminal device of claim 8, wherein the second time-frequency configuration information comprises one or more of: ephemeris information of the second transmission node, downlink frequency pre-compensation information of the second transmission node, uplink frequency post-compensation information of the second transmission node, or timing compensation information of the second transmission node.

12. The terminal device of claim 8, wherein the programming instructions, when executed by the at least one processor, further cause the terminal device to:
receive configuration information from the first transmission node, wherein the configuration information comprises the second time-frequency configuration information and an effective time of the second time-frequency configuration information; and
further transmit, based on the second time-frequency configuration information and after the effective time arrives, the second information on the first transmission resource in the second time period.

13. The terminal device of claim 8, wherein the programming instructions, when executed by the at least one processor, further cause the terminal device to:
receive indication information from the first transmission node, wherein the indication information indicates the second time-frequency configuration information and an effective time of the second time-frequency configuration information in a preconfigured time-frequency configuration set; and
obtain, after the effective time arrives and before transmitting the second information, the second time-frequency configuration information from the preconfigured time-frequency configuration set.

14. The terminal device of claim 8, wherein the programming instructions, when executed by the at least one processor, further cause the terminal device to further transmit the second information on the first transmission resource in the second time period by:
obtaining, after preconfigured effective time of the second time-frequency configuration information arrives, the second time-frequency configuration information from a preconfigured time-frequency configuration set; and
transmitting, based on the second time-frequency configuration information, the first information on the first transmission resource in the second time period.

15. A non-transitory computer-readable storage medium storing computer instructions that, when executed by a terminal device or a module in the terminal device, cause the terminal device to:
transmit, based on first time-frequency configuration information of a first transmission node, first information on a first transmission resource in a first time period, wherein the first transmission node corresponds to the first transmission resource; and
transmit, based on second time-frequency configuration information of a second transmission node, second information on the first transmission resource in a second time period, wherein the second transmission node corresponds to the first transmission resource.

16. The non-transitory computer-readable storage medium of claim 15, wherein the first transmission resource comprises one or more of: a synchronization signal/physical broadcast channel block (SSB) resource, an SSB resource set, or an SSB resource set list.

17. The non-transitory computer-readable storage medium of claim 15, wherein the first time-frequency configuration information of comprises one or more of: ephemeris information of the first transmission node, downlink frequency pre-compensation information of the first transmission node, uplink frequency post-compensation information of the first transmission node, or timing compensation information of the first transmission node.

18. The non-transitory computer-readable storage medium of claim 15, wherein the second time-frequency configuration information comprises one or more of: ephemeris information of the second transmission node, downlink frequency pre-compensation information of the second transmission node, uplink frequency post-compensation information of the second transmission node, or timing compensation information of the second transmission node.

19. The non-transitory computer-readable storage medium of claim 15, wherein the computer instructions, when executed by the terminal device, further cause the terminal device to:
receive configuration information from the first transmission node, wherein the configuration information comprises the second time-frequency configuration information and an effective time of the second time-frequency configuration information; and
further transmit, based on the second time-frequency configuration information and after the effective time arrives, the second information.

20. The non-transitory computer-readable storage medium of claim 15, wherein the computer instructions, when executed by the terminal device, further cause the terminal device to:
receive indication information from the first transmission node, wherein the indication information indicates the second time-frequency configuration information and an effective time of the second time-frequency configuration information in a preconfigured time-frequency configuration set; and
obtain, after the effective time arrives and before transmitting the second information, the second time-frequency configuration information from the preconfigured time-frequency configuration set.
